(19) United States
(12) Patent Application Publication
(10) Pub. No.: US 2012/0110506 A1
(43) Pub. Date: May 3, 2012

(54) System and Method for File Navigation

(75) Inventors: Marianne Kodimer, Huntington Beach, CA (US); William Su, Riverside, CA (US); Michael Yeung, Mission Viejo, CA (US)

(73) Assignees: Toshiba Tec Kabushiki Kaisha, Shinagawa-ku (JP); Kabushiki Kaisha Toshiba, Minato-ku (JP)

(21) Appl. No.: 12/916,418

(22) Filed: Oct. 29, 2010

(51) Int. Cl. G06F 3/048

(52) U.S. Cl. 715/812

(57) ABSTRACT

The subject application is directed to computer file navigation. The identification of a user is received followed by a menu selection instruction. Uniquely identified data storage areas and uniquely identified secondary data storage areas are then defined in a data storage. Each secondary area includes history data relative to the user's prior access. A menu area is then generated that includes use-selectable indicia, each corresponding to one of a subset of the storage areas. A user-positionable pointer is generated on the menu area, a position of the pointer is detected relative to the indicia, and an indicium is generated proximate to the pointer in accordance with the detected position. A listing of secondary areas corresponding to the selected indicium is generated and displayed in an order based on the associated history data. A selection of one the secondary areas is received from the user and its history data is updated.

### BACKGROUND OF THE INVENTION

The subject application is directed generally to menu generation for efficient navigation through file systems. The application is particularly directed to a menu navigation system and method that is rendered more efficiently by automatically displaying or populating files or folders in accordance with each user's prior viewing habits.

User interfaces on data devices, such as computers or document processing devices, have evolved to provide an intuitive and straightforward man-machine interface that is readily viewable as a point-and-click, graphical display. User control or selection commences with selection of a top level of indicia, such as word selections, icons, or both. When a top level is selected, a secondary menu, such as a drop-down menu, is generated that further refines options available from the initial selection.

Shared devices in widespread use include document processing devices, such as printers, facsimile machines, scanners, or copiers. More recently, two or more of these functions are provided in powerful devices referred to as multifunction peripherals (MFPs) or multifunction devices (MFDs). The power and versatility of such devices make them good candidates for control via a graphical user interface, such as a point-and-click system or a touch screen system. These devices are also frequently incorporated with electronic document storage, either locally in memory or a disk drive, or via network-based storage connections.

When many users share a device, navigation via a file system may provide a view to an overwhelming number of files, all but a few being irrelevant to any particular user. Also, a user may have many files that have been stored, even if attention is focused on the user's own files or in the user's own folders.

### SUMMARY OF THE INVENTION

In accordance with one embodiment of the subject application, there is provided a system and method for computer file navigation. Identification data is received corresponding to an identity of an associated user and a menu selection instruction is received from the associated user. A plurality of uniquely identified data storage areas and a plurality of uniquely identified secondary data storage areas are defined in a data storage, each secondary data storage area including history data relative to prior access thereof by the associated user. A menu area is generated on an associated display, the menu area including a plurality of use-selectable indicia, each indicium of the plurality of indicia corresponding to one of a subset of the plurality of data storage areas. A user-positionable pointer is generated on the menu area, a position of the pointer is detected relative to the indicia, and an indicium is generated proximate to the pointer in accordance with the detected position. A listing of a plurality of secondary data storage areas corresponding to the selected indicium is generated and displayed in an order corresponding to history data associated therewith. A selection of one of the plurality of secondary data storage areas is received from the associated user and history data associatively stored with the selected secondary data storage area is updated.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for computer file navigation according to one embodiment of the subject application;

FIG. 2 is a block diagram illustrating device hardware for computer file navigation use in the system for according to one embodiment of the subject application;

FIG. 3 is a functional diagram illustrating the device for computer file navigation use in the system for according to one embodiment of the subject application;

FIG. 4 is a block diagram illustrating controller hardware for computer file navigation use in the system for according to one embodiment of the subject application;

FIG. 5 is a functional diagram illustrating the controller for computer file navigation use in the system for according to one embodiment of the subject application;

FIG. 6 is a functional diagram illustrating a workstation for use in the system for computer file navigation according to one embodiment of the subject application;

FIG. 7 is a functional diagram illustrating a server for use in the system for computer file navigation according to one embodiment of the subject application;

FIG. 8 is a block diagram illustrating the system for computer file navigation according to one embodiment of the subject application;

FIG. 9 is a functional diagram illustrating the system for computer file navigation according to one embodiment of the subject application;

FIG. 10 is a flowchart illustrating a method for computer file navigation according to one embodiment of the subject application;

FIG. 11 is a flowchart illustrating a method for computer file navigation according to one embodiment of the subject application;

FIG. 12 is a flowchart illustrating an example implementation of the method for computer file navigation according to one embodiment of the subject application;

FIG. 13 is a graphical illustration of a control's display field of FIG. 12 with default instructions set by an administrator for use in the method for computer file navigation according to one embodiment of the subject application;

FIG. 14 is a graphical illustration of a control's display field of FIG. 12 with a default root based on history of the logged in user for use in the method for computer file navigation according to one embodiment of the subject application;

FIG. 15 is a graphical illustration of a control's display field of FIG. 12 with a default root value set by an administrator for use in the method for computer file navigation according to one embodiment of the subject application;

FIG. 16 is a graphical illustration of a control's display field of FIG. 12 with history items and administrator defined root items for use in the method for computer file navigation according to one embodiment of the subject application;

FIG. 17 is a graphical illustration of a control's display field of FIG. 12 with administrator defined root items only for use in the method for computer file navigation according to one embodiment of the subject application;

FIG. 18 is a graphical illustration of a control's display field of FIG. 12 with a nested item selected and associated child items displayed for use in the method for computer file navigation according to one embodiment of the subject application;

FIG. 19 is a graphical illustration of a control's display field of FIG. 18 with a nested item selected and associated child items displayed for use in the method for computer file navigation according to one embodiment of the subject application; and

FIG. 20 is a graphical illustration of a control's display field of FIG. 12 depicting an abbreviated path for use in the method for computer file navigation according to one embodiment of the subject application.

### DETAILED DESCRIPTION OF THE PREFERRED EMBODIMENT

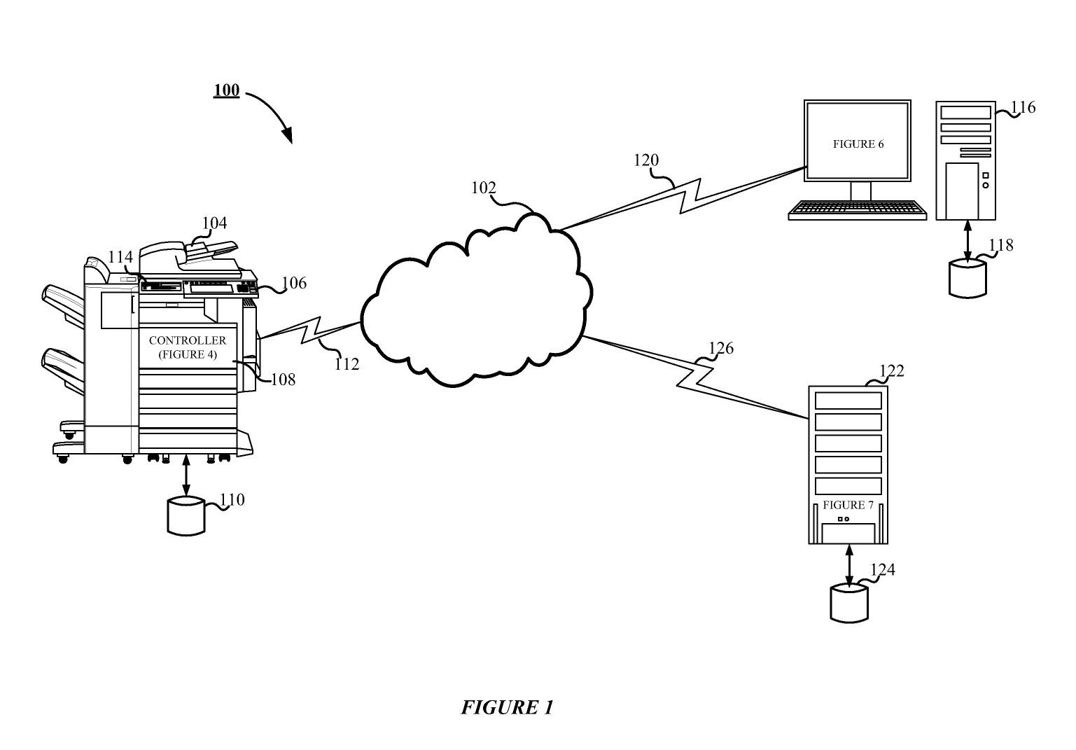

The subject application is directed to a system and method for computer file navigation. The subject application is directed to menu generation for efficient navigation through file systems. The application is particularly directed to a menu navigation system and method that is rendered more efficiently by automatically displaying or populating files or folders in accordance with each user's prior viewing habits. It will become apparent to those skilled in the art that the system and method described herein are suitably adapted to a plurality of varying electronic fields employing templates, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for computer file navigation in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

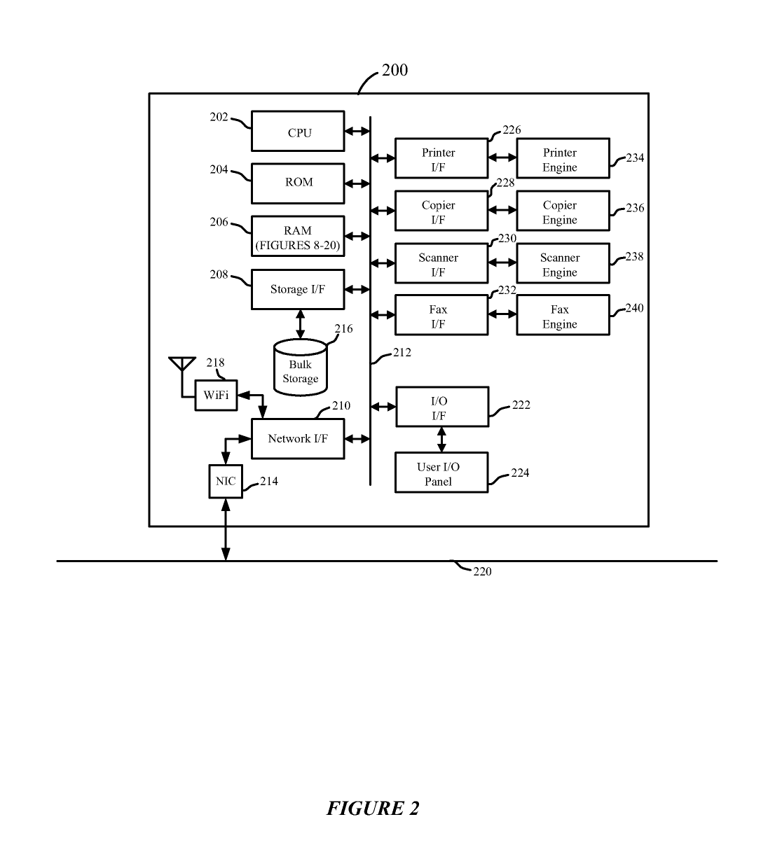

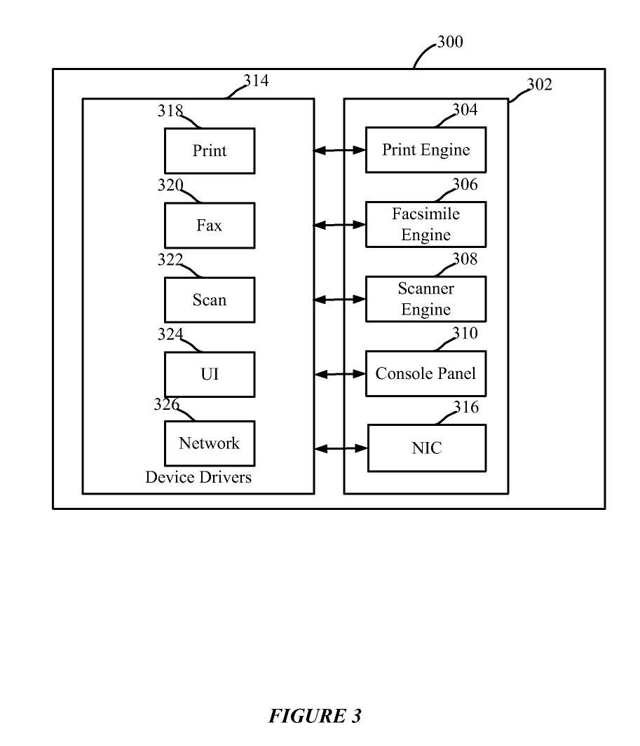

According to one embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

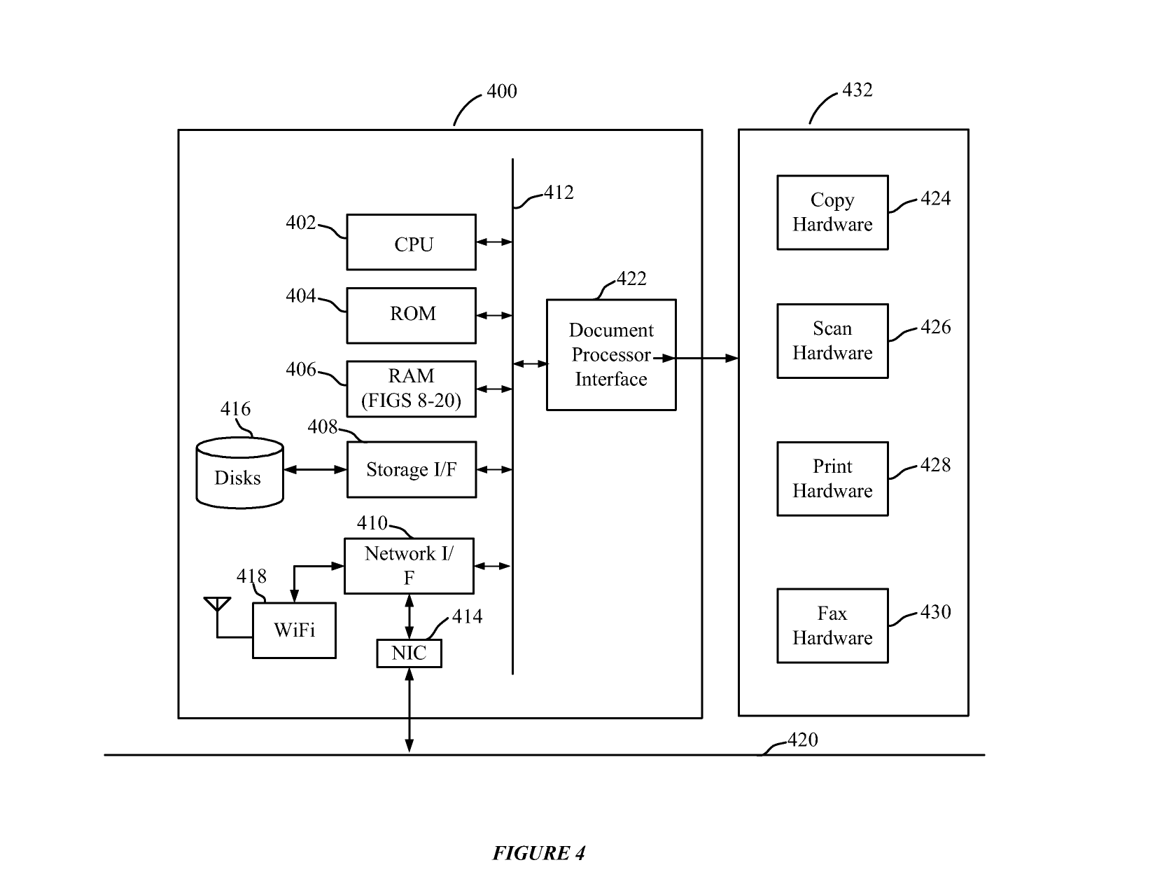

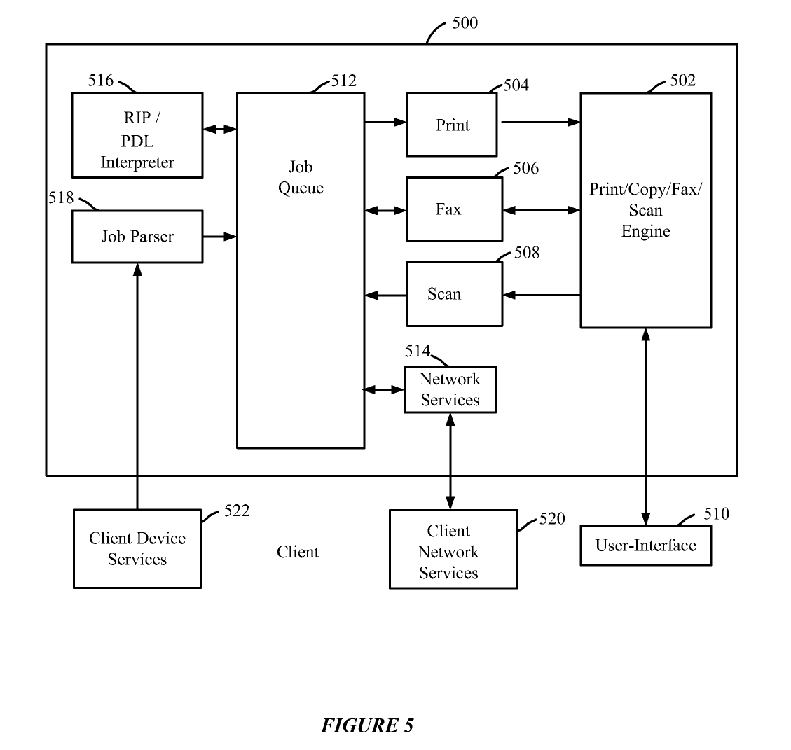

In accordance with one embodiment of the subject application, the document processing device 104 incorporates a backend component, designated as the controller 108, and suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for altering document output properties in accordance with altering intercepted print stream data of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, character set data, user-supplied data fields, modified image data, redacted data, user information, cellular telephone data, document processing instructions, graphical user interface data, customer information, workflow data, payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. The document processing device of FIG. 1 also includes a portable storage device reader 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a user device 116, illustrated as a computer workstation in data communication with the computer network 102 via a communications link 118. It will be appreciated by those skilled in the art that the user device 116 is shown in FIG. 1 as a workstation computer for illustration purposes only. As will be understood by those skilled in the art, the user device 116 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the user device 116 further includes software, hardware, or a suitable combination thereof configured to interact with the document processing device 104, or the like.

Communicatively coupled to the user device 116 is the data storage device 118. According to one example embodiment of the subject application, the data storage device 118 is any mass storage device, or plurality of such devices, known in the art including, for example and without limitation, magnetic storage drives, a hard disk drive, optical storage devices, flash memory devices, or any suitable combination thereof. In such an embodiment, the data storage device 118 is suitably adapted to store page job language data, printer control language data, page description language data, page display language filters, search patterns, preselected data strings, account information, template data, electronic document data, electronic form data, scanned electronic image data, and the like. It will be appreciated by those skilled in the art that while illustrated in FIG. 1 as being a separate component of the system 100, the data storage device 118 is capable of being implemented as an internal storage component of the user device 116, or the like, such as, for example and without limitation, an internal hard disk drive, or the like.

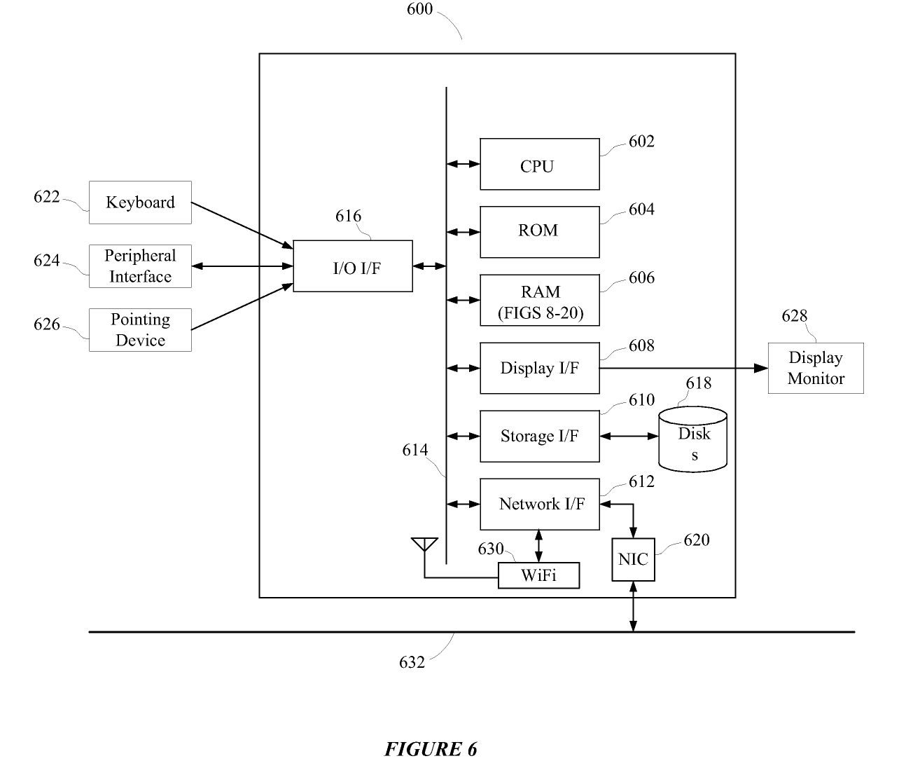

The communications link 120 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 116 is suitably adapted to provide document data, job data, filter functionality, user interface data, image data, monitor document processing jobs, employ thin-client interfaces, generate display data, generate output data, or the like, with respect to the document processing device 104, or any other similar device coupled to the computer network 102. The functioning of the user device 116 will better be understood in conjunction with the block diagram illustrated in FIG. 6, explained in greater detail below.

The system 100 illustrated in FIG. 1 further depicts a backend component, shown as the server 122, in data communication with the computer network 102 via a communications link 126. It will be appreciated by those skilled in the art that the server 122 is shown in FIG. 1 as a component of the system 100 for example purposes only, and the subject application is capable of implementation without the use of a separate backend server component, e.g. the server 122 is capable of implementation via the document processing device 104, or via the user device 116. The skilled artisan will appreciate that the server 122 comprises hardware, software, and combinations thereof suitably adapted to provide one or more services, web-based applications, storage options, and the like, to networked devices. In accordance with one example embodiment of the subject application, the server 122 includes various components, implemented as hardware, software, or a combination thereof, managing retention of print stream filters, managing retention of documents, text data, performing searches, comparisons, maintaining database entries, account information, receiving payment data, retrieval of documents, and the like, which are accessed via the computer network 102.

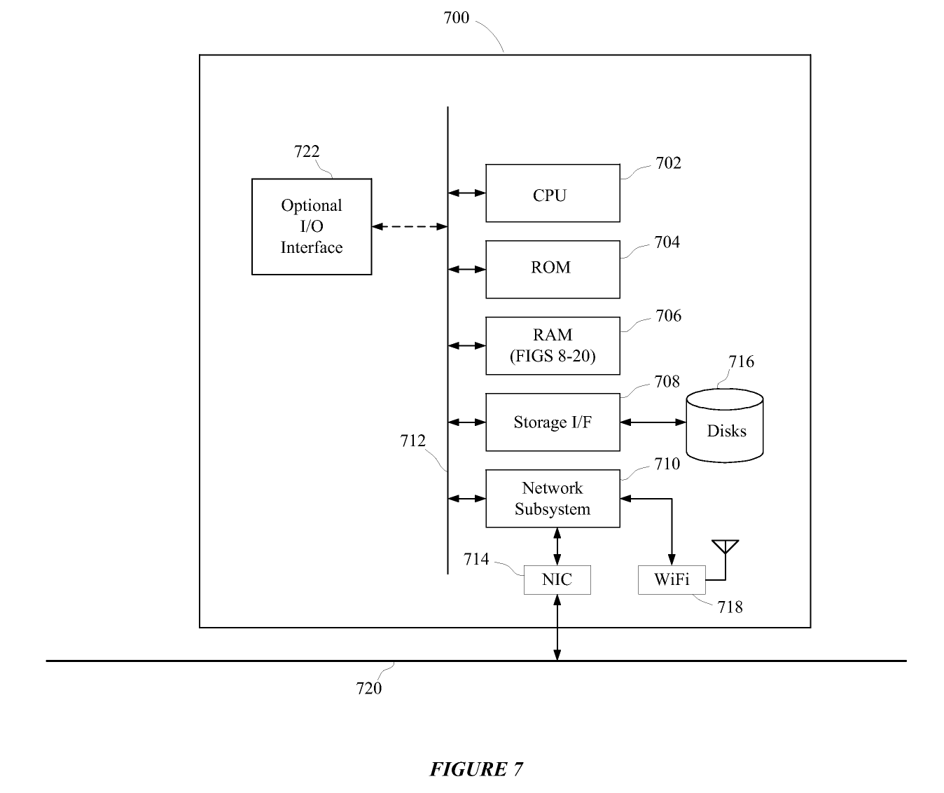

The communications link 126 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 122 are capable of implementation on any suitable computing device coupled to the computer network 102, e.g. the controller 108, or the like. The functioning of the server 122 will better be understood in conjunction with the block diagram illustrated in FIG. 7, explained in greater detail below.

Communicatively coupled to the server 122 is the data storage device 124. According to the foregoing example embodiment, the data storage device 122 is any mass storage device, or plurality of such devices, known in the art including, for example and without limitation, magnetic storage drives, a hard disk drive, optical storage devices, flash memory devices, or any suitable combination thereof. In such an embodiment, the data storage device 124 is suitably adapted to store print stream filters, page display language filters, search patterns, preselected data strings, user information, database information, a document management system data, electronic documents, tag data, positioning data, layout data, and the like. It will be appreciated by those skilled in the art that while illustrated in FIG. 1 as being a separate component of the system 100, the data storage device 124 is capable of being implemented as an internal storage component of the server 122, or the like, such as, for example and without limitation, an internal hard disk drive, or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown as the user device 116, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

Turning now to FIG. 7, illustrated is a representative architecture of a suitable server 700 (depicted in FIG. 1 as the server 122), on which operations of the subject system are completed. Included is a processor 702, suitably comprised of a central processor unit. However, it will be appreciated that processor 702 may advantageously be composed of multiple processors working in concert with one another as will be appreciated by one of ordinary skill in the art. Also included is a non-volatile or read only memory 704 which is advantageously used for static or fixed data or instructions, such as BIOS functions, system functions, system configuration, and other routines or data used for operation of the server 700.

Also included in the server 700 is random access memory 706, suitably formed of dynamic random access memory, static random access memory, or any other suitable, addressable memory system. Random access memory provides a storage area for data instructions associated with applications and data handling accomplished by the processor 702.

A storage interface 708 suitably provides a mechanism for volatile, bulk or long term storage of data associated with the server 700. The storage interface 708 suitably uses bulk storage, such as any suitable addressable or serial storage, such as a disk, optical, tape drive and the like as shown as 716, as well as any suitable storage medium as will be appreciated by one of ordinary skill in the art.

A network interface subsystem 710 suitably routes input and output from an associated network allowing the server 700 to communicate to other devices. The network interface subsystem 710 suitably interfaces with one or more connections with external devices to the server 700. By way of example, illustrated is at least one network interface card 714 for data communication with fixed or wired networks, such as Ethernet, token ring, and the like, and a wireless interface 718, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 714 is interconnected for data interchange via a physical network 720, suitably comprised of a local area network, wide area network, or a combination thereof.

Data communication between the processor 702, read only memory 704, random access memory 706, storage interface 708 and the network subsystem 710 is suitably accomplished via a bus data transfer mechanism, such as illustrated by bus 712.

Suitable executable instructions on the server 700 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 722 as will be appreciated by one of ordinary skill in the art.

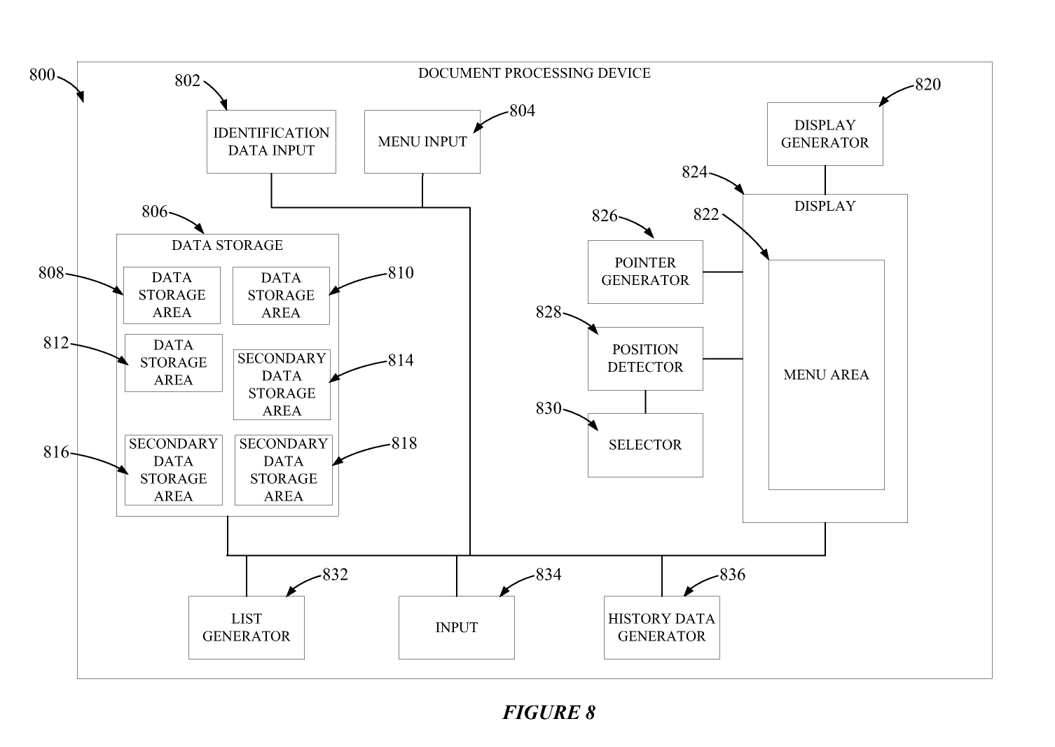

Referring now to FIG. 8, illustrated is a block diagram of a computer file navigation system 800 in accordance with one embodiment of the subject application. The computer file navigation system 800 includes an identification data input 802 that is configured to receive identification data corresponding to the identity of an associated user. The system 800 further includes a menu input 804 that is configured to receive a menu selection instruction from the associated user. The system 800 also incorporates a data storage 806 that contains a group of uniquely identified data storage areas 808, 810, and 812, and a group of uniquely identified secondary data storage areas 814, 816, and 818. In accordance with one embodiment of the subject application, each of the secondary data storage areas 814, 816, and 818 include history data relative to the prior access of the area 814, 816, or 818 by the associated user.

As illustrated in FIG. 8, the system 800 employs a display generator 820 that is operable to generate a menu area 822 on an associated display 824. According to one embodiment of the subject application, the menu area 822 includes a plurality of user-selectable indicia, each indicium of the plurality of indicia corresponding to one of a subset of the plurality of data storage areas 808-818. The computer file navigation system 800 also employs a pointer generator 826 that is capable of generating a user-positionable pointer on the menu area 822, and a position detector 828 configured to sense the position of the pointer relative to the indicia.

In addition, the system 800 uses a selector 830 to select an indicium proximate to the pointer based upon the output of the position detector 828. A list generator 832 is then employed to generate a listing of secondary data storage areas 814-818 that correspond to the selected indicium. Preferably, the listing is displayed in an order corresponding to history data associated with each of the secondary data storage areas 814-818. The system 800 further includes an input 834 that is operable to receive a selection of one of the secondary data storage areas 814-818 from the associated user. Furthermore, the computer file navigation system 800 uses a history data generator 836 configured to update the history data that is associatively stored with the selected secondary data storage area 814, 816, or 818.

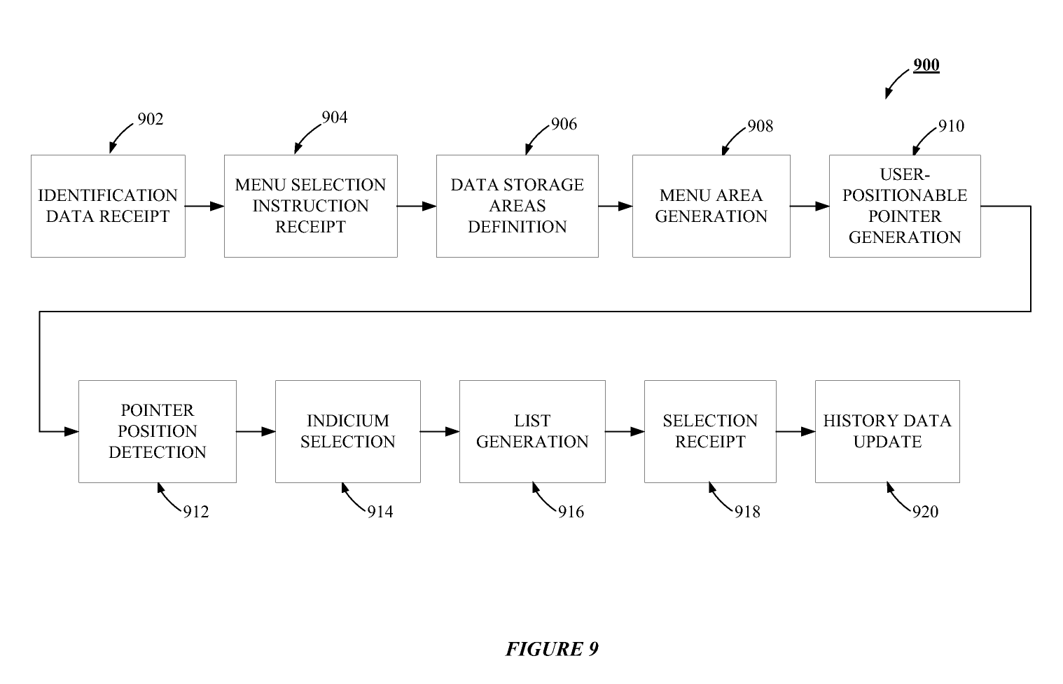

Turning now to FIG. 9, illustrated is a functional diagram of a computer file navigation system 900 in accordance with one embodiment of the subject application. As shown in FIG. 9, identification data receipt 902 first occurs of data corresponding to the identity of an associated user, followed by menu selection instruction receipt 904 from the associated user. Data storage area definition 906 is then performed for uniquely identified data storage areas and uniquely identified secondary data storage areas. Preferably, each secondary data storage area includes history data relative to the prior access of the corresponding secondary area by the associated user.

Menu area generation 908 is then performed on an associated display. This menu area includes user-selectable indicia, with each indicium corresponding to one of a subset of data storage areas. User-positionable pointer generation 910 is also performed so as to generate a pointer on the menu area. Pointer position detection 912 then occurs of the position of the pointer relative to the indicia. Indicium selection 914 is then performed of an indicium that is proximate to the pointer as indicated by the detected position. List generation 916 then occurs of a list of secondary storage areas that correspond to the selected indicium. Preferably, the list generated is displayed in an order that corresponds to the history data associated with each area. Next, selection receipt 918 occurs of one of the secondary storage areas by the user, followed thereafter by history data update 920 performed on the history data stored in association with the secondary data storage area.

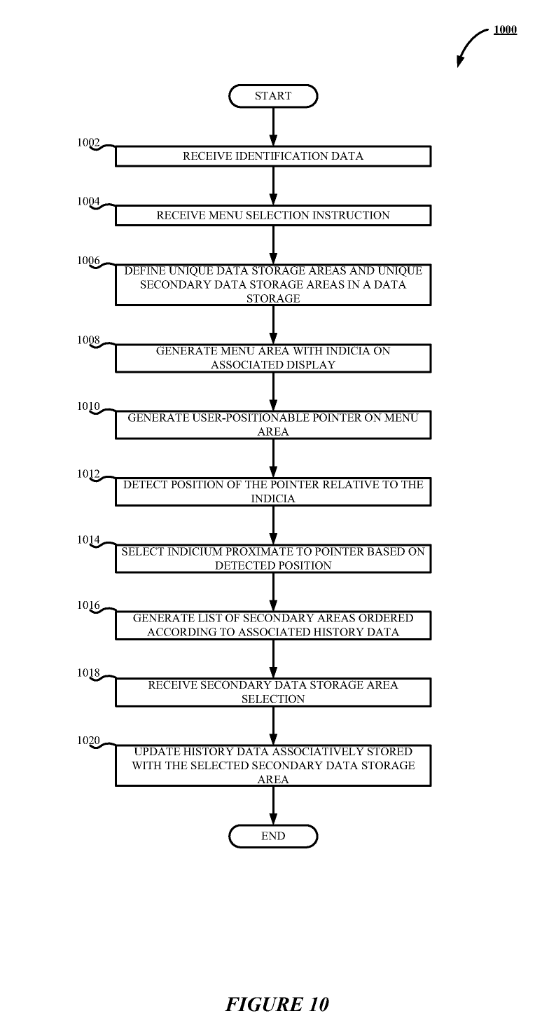

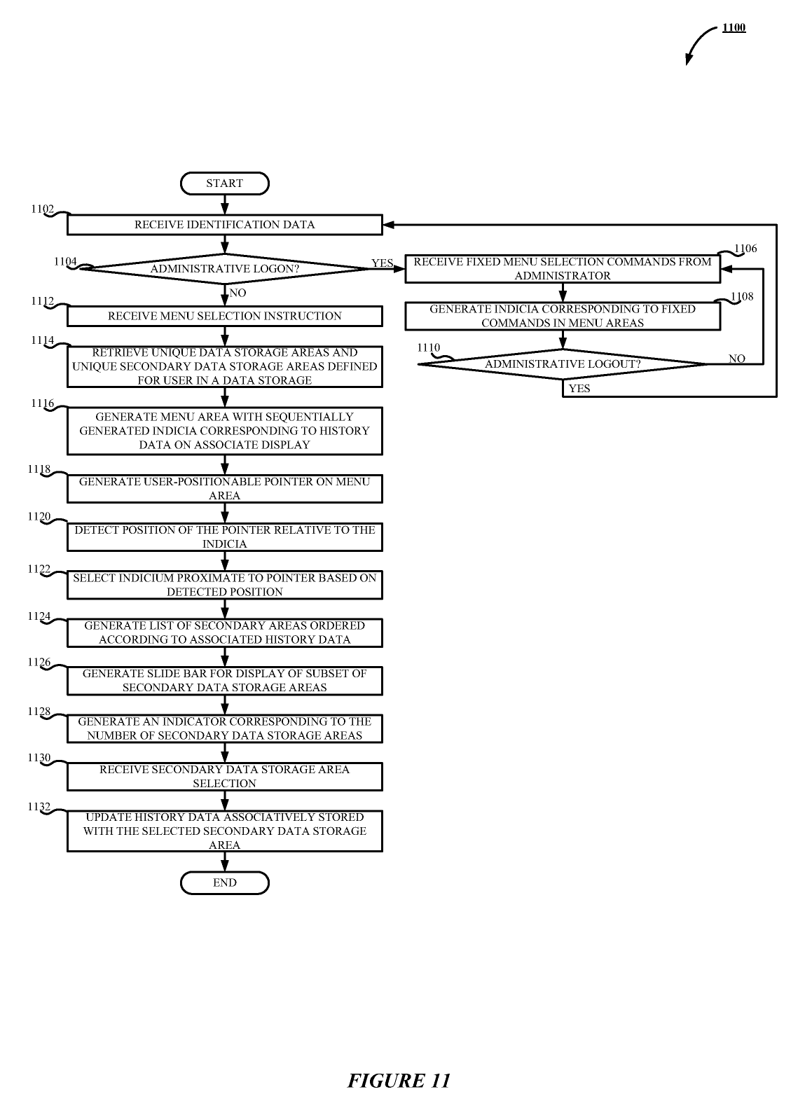

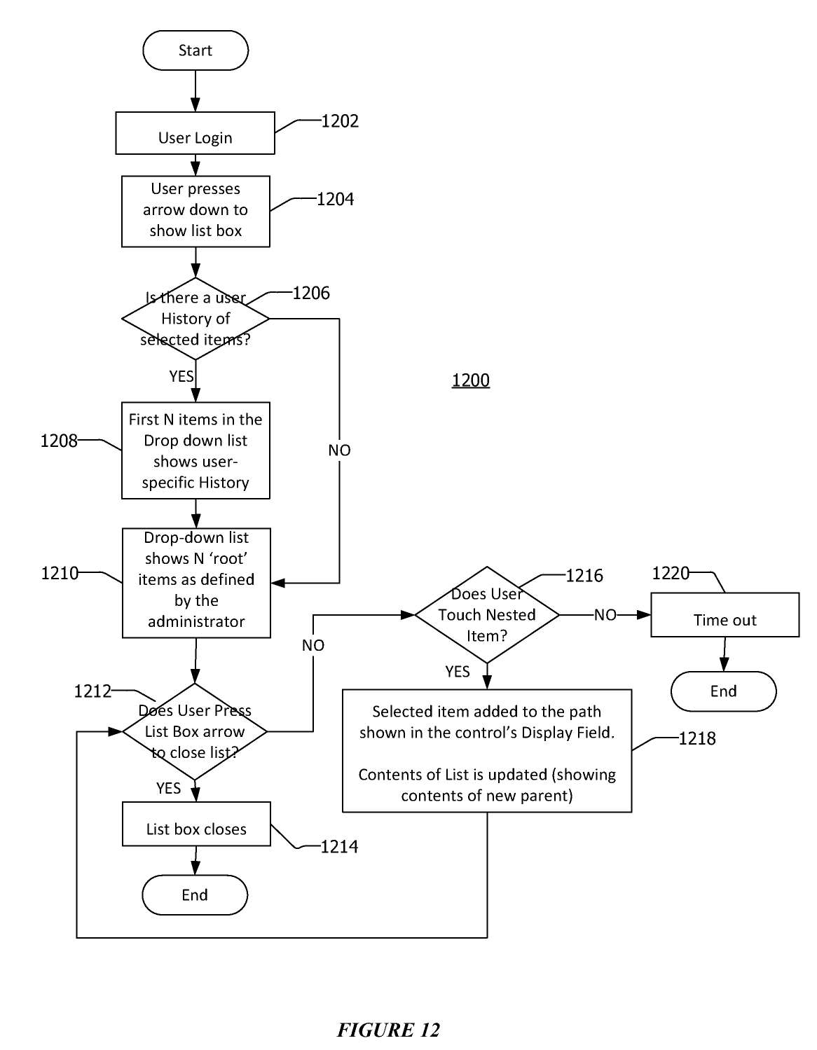

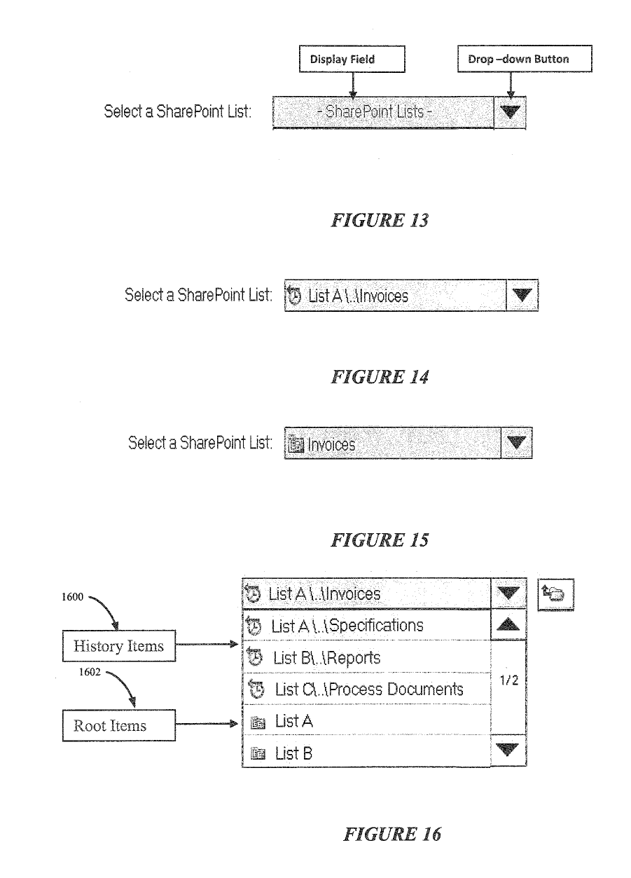

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11, as well as the example illustrations of the embodiments depicted in FIG. 12, FIG. 13, FIG. 14, and FIG. 15. Turning now to FIG. 9, there is shown a flowchart 1000 illustrating a method for generating a user-adaptable interface presentation on a document processing device in accordance with one embodiment of the subject application. Beginning at step 1002, identification data is received that corresponds to the identity of an associated user. A menu selection instruction is then received from this associated user at step 1004. A plurality of uniquely identified data storage areas and a plurality of uniquely identified secondary data storage areas are then defined, at step 1006, in a data storage. In accordance with one embodiment of the subject application, each of these secondary storage areas include history data that is reflects the prior access by the associated user of each particular area.

A menu area is then generated on an associated display at step 1008. According to one embodiment of the subject application, the menu area includes a plurality of use-selectable indicia, with each indicium in this plurality of indicia corresponding to one of a subset of the data storage areas. A user-positionable pointer is then generated on the menu area at step 1010. The position of the pointer is then detected at step 1012 relative to the indicia. An indicium is then selected at step 1014 proximate to the pointer based upon this detected position.

At step 1016, a listing of a plurality of secondary data storage areas corresponding to the selected indicium is generated and displayed in an order that corresponds to the history data that is associated with each secondary area. A selection is then received, at step 1018, from the associated user of one of the plurality of secondary data storage areas. The history data associatively stored with the selected secondary data storage area is then updated at step 1020.

Referring now to FIG. 11, there is depicted a flowchart 1100 illustrating a method for document processing workflow in accordance with one example embodiment of the subject application. The methodology of FIG. 11 begins at step 1102, whereupon identification data is received from an associated user via the user interface 106 or other suitable component associated with the document processing device 104. At step 1104, the identification data is analyzed to determine whether the login corresponds to an administrative user. Upon a positive determination at step 1104, flow proceeds to step 1106, whereupon fixed menu selection commands are received from the administrator. It will be appreciated by those skilled in the art that such menu selection commands correspond to fixed directories, icons, operations, or the like. Indicia corresponding to these fixed menu selection commands are then generated for the menu area of the user interface 106. Following indicia generation, operations progress to step 1110, whereupon a determination is made whether the administrative user has logged off the document processing device 104. In the event that administrative log off has not occurred, flow returns to step 1106 for menu selection commands. Upon log off of the administrative user, flow returns to step 1002.

Upon a determination at step 1104 that no administrative logon is detected, operations progress to step 1112. At step 1012, a menu selection instruction is received from the associated user via the user interface 106 or other suitable component associated with the document processing device 104. Upon receipt of the menu selection instruction, flow proceeds to step 1114, whereupon unique data storage areas and unique secondary data storage areas defined for the user are retrieved from an associated data storage, e.g. the data storage 110, the data storage 118, the data storage 124, or the like. Those skilled in the art will appreciate that such areas are capable of being accessed by the document processing device 104 via the computer network 102. According to one embodiment of the subject application, the unique storage areas are file directories and the secondary storage areas are unique electronic documents.

A menu area is then generated on the user interface 106 that includes multiple user-selectable indicia at step 1116. Each of these indicium preferably corresponds to one of a subset of the storage areas. Preferably, the indicia generated at step 1116 are generated sequentially in accordance with history data associated with each storage area. In accordance with one embodiment of the subject application, the history data corresponds to past access, modification, editing, or other interactions between the associated user and the corresponding storage area. At step 1118, a user-positionable pointer is generated on the menu area. The position of the pointer is then detected, at step 1120, relative to the indicia of the menu area.

At step 1122, indicium proximate to the pointer based on the detected position is then selected. A list of secondary areas, ordered based upon associated history data, is then generated via the controller 108 or other suitable component associated with the document processing device 104 at step 1124. Preferably, this listing is suitably displayed to the associated user via the user interface 106. A slide bar is then generated for the display of a subset of secondary data storage areas at step 1126 on the user interface 106. It will be appreciated by those skilled in the art that such a slide bar enables the associated user to scroll up or down amongst those data storage areas displayed in the menu area. An indicator is then generated at step 1128 corresponding to the number of secondary data storage areas, i.e. documents or files, in the generated list. A selection of a secondary storage area is then received from the user via the user interface 106 at step 1130. Thereafter, at step 1132, the history data associatively stored with the selected secondary data storage area is then updated to reflect the current access by the associated user. The preceding embodiment will be better understood in conjunction with the example operation of FIG. 12 and corresponding graphical representations of FIGS. 13-20.

Turning now to FIG. 12, there is shown a flowchart 1200 illustrating an example of the method for generating a user-adaptable interface presentation on a document processing device implemented in accordance with one embodiment of the subject application. The flowchart 1200 begins at step 1202, whereupon the user logs onto the document processing device 104 via the user interface 106 or other suitable component associated with the document processing device 104. Preferably, the log on of the user results in the generation of a default display field that is based on instructional information as set by the administrator (depicted in FIG. 13), a default value (root) based on the history associated with the user's login information (depicted in FIG. 14), and/or a default (root) value set by the administrator (depicted in FIG. 15).

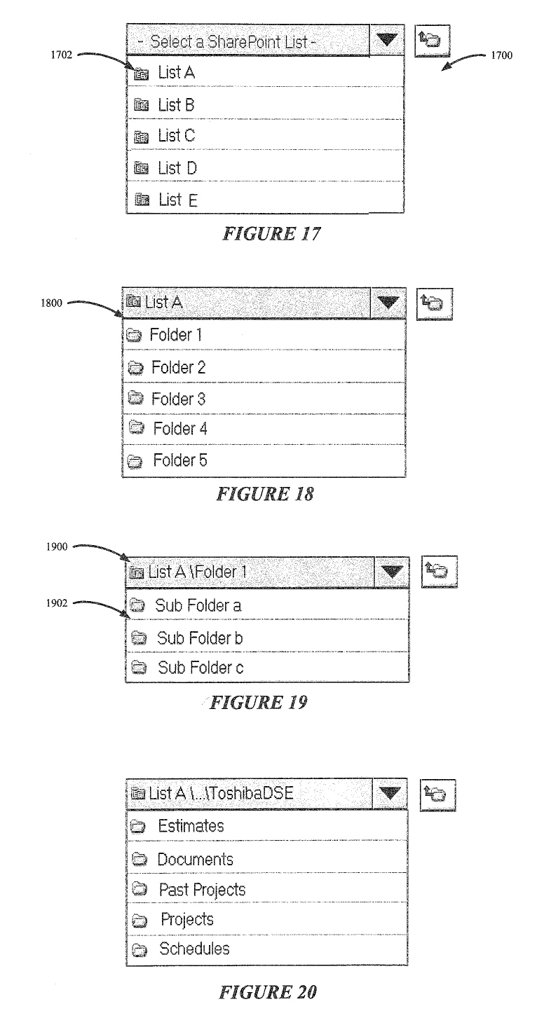

The user then presses, at step 1204, arrow down to show the listings displayed as a result of the login. At step 1206, a determination is made whether any user history is available that affects the order and content displayed to the user. Upon a positive determination at step 1206, flow proceeds to step 1208, whereupon the first N items of the drop-down list shows user-specific history. In the event that no history is available, or after retrieval of the history, flow progresses to step 1210, whereupon the listing of items includes N ‘root’ items, as defined by the administrator. FIG. 16 illustrates a menu area wherein a history of N items 1600 and N root items, with N defined by the administrator. In accordance with one embodiment of the subject application, a history is stored by the system, e.g. the server 122, the controller 108, or the like, which is associated with the user login credentials. As will be appreciated by those skilled in the art, history items include, for example and without limitation, locations, paths, or the like, which are stored when the user exits the screen or workflow. In accordance with one particular embodiment of the subject application, investigative locations or selections made prior to exiting the screen or the workflow are not added to the history. The set of ‘root’ destinations 1602, such as SharePoint Lists or Network Drives is also set by the administrator and serve as navigation starting points for the end user. FIG. 17 illustrates an example list 1700 of root destinations displayed to the user upon a determination that a history does not yet exist.

Returning to FIG. 12, a determination is then made at step 1212 whether the user has selected the close list option. Upon such a determination, flow proceeds to step 1214 with the closing of the box and termination of operations with respect to FIG. 12. Upon a negative determination at step 1212, flow proceeds to step 1216. At step 1216, a determination is made whether the user has touched a nested item. That is, whether the user has selected one of the items listed on the display 106. Upon a determination at step 1216 that the user has not touched a nested item, a time out determination occurs at step 1220, whereupon operations with respect to FIG. 12 are terminated.

When a nested item has been selected by the user, operations proceed to step 1218, whereupon the selected item added to the path shown in the control's display field and the contents of the list are updated to show the contents of the new parent (associated child items). Thereafter, flow returns to step 1212 for user selection of a close box or touch nested item. For example, when the item “List A” 1702 is selected from the list 1700 in FIG. 17, the label of the item is shown in the display field and the drop down list is updated to show the children 1800 of “List A”, shown in FIG. 18. Such process continues, for example, when the item “Folder 1” 1900 is selected, the contents are updated to contain child folders 1902 of “Folder 1” 1900, as demonstrated in FIG. 19. According to the example illustration of FIG. 12, the drop-down control's display field is associated with an arrow down control used to toggle between showing and hiding the associated list of nested items. Preferably, listed items will illustrate the appropriate icon (e.g., folder, directory, list, or the like), a list scrollbar is shown only if more than one page in the drop down list exists, and the current page of total pages, .e.g. 2 of 7 or 2/7, is shown on the drop down list scrollbar. In addition, the folder up/back button navigates up one level, with the drop down list and display field refreshed accordingly. FIG. 20 illustrates the automatic scrolling of the display field 2000 to show at least final item, as well as the parent of the current list, so as to provide meaningful feedback/context to the selection.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A computer file navigation system comprising:
an input operable to receive identification data corresponding to an identity of an associated user;
an input operable to receive a menu selection instruction from the associated user;
a data storage having a plurality of uniquely identified data storage areas and a plurality of uniquely identified secondary data storage areas, each secondary data storage area including history data relative to prior access thereof by the associated user;
a display generator operable to generate a menu area on an associated display, the menu area including a plurality of user-selectable indicia, each indicium of the plurality of indicia corresponding to one of a subset of the plurality of data storage areas;
a pointer generator operable to generate a user-positionable pointer on the menu area;
a position detector operable to sense a position of the pointer relative to the indicia;
a selector operable to select an indicium proximate to the pointer in accordance with an output of the position detector;
a list generator operable to generate a listing of a plurality of secondary data storage areas corresponding to the selected indicium displayed in an order corresponding to history data associated therewith;
an input operable to receive a selection of one of the plurality of secondary data storage areas from the associated user; and
a history data generator operable to update history data associatively stored with the selected secondary data storage area.

2. The system of claim 1 wherein the plurality of secondary data storage areas comprise a corresponding plurality of electronic documents.

3. The system of claim 2 further comprising:
an input operable to receive fixed menu selection commands from an associated administrator; and
wherein the display generator is further operable to generate indicia in the menu area corresponding to received fixed menu selection commands.

4. The system of claim 2 wherein the display generator is operable to generate a slide bar so as to allow a subset of the secondary data storage areas to be displayed in accordance with a user positioning thereof when a number of secondary data storage areas achieves a defined threshold value.

5. The system of claim 2 wherein the plurality of data storage areas comprise file directories on the data storage.

6. The system of claim 1 wherein the display generator is further operable to sequentially generate the indicia corresponding to the history data.

7. The system of claim 2 wherein the display generator is further operable to generate an indicator corresponding to a number of the secondary data storage areas.

8. A method for computer file navigation comprising:
receiving identification data corresponding to an identity of an associated user;
receiving a menu selection instruction from the associated user;
defining, in a data storage, a plurality of uniquely identified data storage areas and a plurality of uniquely identified secondary data storage areas, each secondary data storage area including history data relative to prior access thereof by the associated user;
generating a menu area on an associated display, the menu area including a plurality of use-selectable indicia, each indicium of the plurality of indicia corresponding to one of a subset of the plurality of data storage areas;
generating a user-positionable pointer on the menu area;
detecting a position of the pointer relative to the indicia;
selecting an indicium proximate to the pointer in accordance with the detected position;
generating a listing of a plurality of secondary data storage areas corresponding to the selected indicium displayed in an order corresponding to history data associated therewith;
receiving a selection of one of the plurality of secondary data storage areas from the associated user; and
updating history data associatively stored with the selected secondary data storage area.

9. The method of claim 8 wherein the plurality of secondary data storage areas comprise a corresponding plurality of electronic documents.

10. The method of claim 9 further comprising:
receiving fixed menu selection commands from an associated administrator; and
generating indicia in the menu area corresponding to received fixed menu selection commands.

11. The method of claim 9 further comprising generating a slide bar so as to allow a subset of the secondary data storage areas to be displayed in accordance with a user positioning thereof when a number of secondary data storage areas achieves a defined threshold value.

12. The method of claim 9 wherein the plurality of data storage areas comprise file directories on the data storage.

13. The method of claim 8 further comprising sequentially generating the indicia corresponding to the history data.

14. The method of claim 9 further comprising generating an indicator corresponding to a number of the secondary data storage areas.

15. A system for computer file navigation comprising:
means adapted for receiving identification data corresponding to an identity of an associated user;
means adapted for receiving a menu selection instruction from the associated user;
means adapted for defining, in a data storage, a plurality of uniquely identified data storage areas and a plurality of uniquely identified secondary data storage areas, each secondary data storage area including history data relative to prior access thereof by the associated user;
means adapted for generating a menu area on an associated display, the menu area including a plurality of use-selectable indicia, each indicium of the plurality of indicia corresponding to one of a subset of the plurality of data storage areas;
means adapted for generating a user-positionable pointer on the menu area;
means adapted for detecting a position of the pointer relative to the indicia;
means adapted for selecting an indicium proximate to the pointer in accordance with the detected position;
means adapted for generating a listing of a plurality of secondary data storage areas corresponding to the selected indicium displayed in an order corresponding to history data associated therewith;
means adapted for receiving a selection of one of the plurality of secondary data storage areas from the associated user; and
means adapted for updating history data associatively stored with the selected secondary data storage area;

16. The system of claim 15 wherein the plurality of secondary data storage areas comprise a corresponding plurality of electronic documents.

17. The system of claim 16 further comprising:
means adapted for receiving fixed menu selection commands from an associated administrator; and
means adapted for generating indicia in the menu area corresponding to received fixed menu selection commands.

18. The system of claim 9 further comprising means adapted for generating a slide bar so as to allow a subset of the secondary data storage areas to be displayed in accordance with a user positioning thereof when a number of secondary data storage areas achieves a defined threshold value.

19. The system of claim 16 wherein the plurality of data storage areas comprise file directories on the data storage.

20. The method of claim 15 further comprising means adapted for sequentially generating the indicia corresponding to the history data.

21. The system of claim 16 further comprising means adapted for generating an indicator corresponding to a number of the secondary data storage areas.
